(19) United States
(12) Patent Application Publication
(10) Pub. No.: US 2013/0222888 A1
(43) Pub. Date: Aug. 29, 2013

(54) ELECTROPHORETIC PARTICLE, ELECTROPHORETIC PARTICLE DISPERSION LIQUID, DISPLAY MEDIUM, AND DISPLAY DEVICE

(71) Applicants: Fuji Xerox Co., Ltd., (US); Fujifilm Corporation, (US)

(72) Inventors: Chisato URANO, Kanagawa (JP); Hiroaki MORIYAMA, Kanagawa (JP); Yasuo YAMAMOTO, Kanagawa (JP); Tadanobu SATO, Kanagawa (JP)

(73) Assignees: FUJIFILM CORPORATION, Tokyo (JP); FUJI XEROX CO., LTD., Tokyo (JP)

(21) Appl. No.: 13/719,614

(22) Filed: Dec. 19, 2012

(30) Foreign Application Priority Data
Feb. 27, 2012 (JP) 2012-040631

(51) Int. Cl. G02F 1/167

(52) U.S. Cl. CPC G02F 1/167
USPC 359/296; 252/519.34

(57) ABSTRACT

There is provided an electrophoretic particle which contains a polymer and a coloring agent, wherein the total content of a calcium element and a sodium element or a magnesium element and a sodium element is about 0.1% by mass or less, an electrophoretic particle dispersion liquid which contains a dispersion medium and the electrophoretic particle dispersed therein.

### CROSS-REFERENCE TO RELATED APPLICATIONS

This application is based on and claims priority under 35 USC 119 from Japanese Patent Application No. 2012-040631 filed on Feb. 27, 2012.

### BACKGROUND

1. Field

The present invention relates to an electrophoretic particle, an electrophoretic particle dispersion liquid, display medium, and display device.

2. Description of the Related Art

As display media capable of repeatedly rewriting, display media using electrophoretic particles are conventionally known.

These display media are composed of, for example, a pair of substrates and a group of electrophoretic particles enclosed between the substrates so as to be moved between the substrates according to the electric field formed between the pair of substrates. Further, there are cases where spacing member is provided to partition the space between the substrates to a plurality of cells for the purpose of preventing the electrophoretic particles from localizing in a specific region in the substrates.

For example, JP-A-2005-107394 (The term “JP-A” as used herein refers to an “unexamined published Japanese patent application”.) proposes “particle for a display device having a positively or negatively chargeable property and a color, which is manufactured by using at least a calcium compound, wherein the concentration of the calcium compound contained in the particles for display device is 0.05% by weight or less in terms of a calcium element”.

Further, JP-A-2006-003510 proposes “particle for a display device having a positively or negatively chargeable property and a color, which contains a calcium element in an amount of 0.03 mg/100 mg or more and 0.1 mg/100 mg or less of the entire particle amount, and a nitrogen atom in an amount of 0.004 mmol/g or more and less than 0.03 mmol/g”.

### SUMMARY

<1> An electrophoretic particle containing:

a polymer and a coloring agent, wherein the total content of a calcium element and a sodium element or a magnesium element and a sodium element is about 0.1% by mass or less.

### BRIEF DESCRIPTION OF THE DRAWINGS

FIG. 1 is a schematic drawing of the display device according to the exemplary embodiment.

FIGS. 2A, 2B are drawings typically showing the moving modes of the particles at the time when voltage is applied to between the substrates of the display medium of the display device according to the exemplary embodiment,

wherein

10 denotes Display device, 12 denotes Display medium, 16 denotes Voltage applying unit, 18 denotes Controlling unit, 20 denotes Display substrate, 22 denotes Rear substrate, 24 denotes Spacing member, 34 denotes Particle group, 36 denotes Reflecting particle group, 38 denotes Supporting substrate, 40 denotes Surface electrode, 42 denotes Surface layer, 44 denotes Supporting substrate, 46 denotes Rear electrode, 48 denotes Surface layer and 50 denotes Dispersion medium.

### DETAILED DESCRIPTION

An exemplary embodiment which is one example according to the invention will be described below.

### [Electrophoretic Particle]

The electrophoretic particle in the exemplary embodiment is an electrophoretic particle obtained by suspending a polymerization component, a coloring agent, metal carbonate and sodium chloride in an aqueous phase and polymerizing the polymerization component.

The electrophoretic particle in the exemplary embodiment is composed by containing the polymer of the polymerization component and the coloring agent, and the total content of the metal element deriving from the metal carbonate and the sodium element deriving from the sodium chloride is 0.1% by mass or less or about 0.1% by mass or less.

That is, when calcium carbonate is used as the metal carbonate in the electrophoretic particle in the exemplary embodiment, the total content of the calcium element and the sodium element is 0.1% by mass or less or about 0.1% by mass or less, and when magnesium carbonate is used, the total content of the magnesium element and the sodium element is 0.1% by mass or less or about 0.1% by mass or less.

As the manufacturing method of an electrophoretic particle, a suspension polymerization method of suspending, together with a polymerization component and a coloring agent, metal carbonate as the dispersant (calcium carbonate or magnesium carbonate), and sodium chloride as the salting agent of the polymerization component in an aqueous phase, and then polymerizing the polymerization component in the presence of the metal carbonate and sodium chloride is conventionally known.

However, it has been known that an electrophoretic particle obtained by the suspension polymerization method lower in the stability of display repetition. Specifically, for example, it has come to be found that a phenomenon of the variation in the adhesion of the electrophoretic particle and the substrate (variation in the threshold voltage) occurs.

Incidentally, concerning the particles for display which are used in conventional display devices which perform display by moving the particles between the substrates by charging the particles for display by means of frictional charging, techniques of reducing the amount of calcium are known (refer to JP-A-2005-107394 and JP-A-2006-003510), but it has come to be known that in the case of the electrophoretic particle, the stability of display repetition still lowers by the reduction of the amount of calcium alone.

In the electrophoretic particle according to the exemplary embodiment, it has been found that the stability of display repetition can be maintained by reducing the total content of the metal element deriving from the metal carbonate and the sodium element deriving from the sodium chloride to 0.1% by mass or less or about 0.1% by mass or less.

The reason for this is not clear but presumably due to the fact that the metal element and the sodium element contained in the electrophoretic particles are eluted into the solvent to inhibit the variation in quantity of charge of the electrophoretic particles.

The electrophoretic particle according to the exemplary embodiment will be described in detail below.

In the electrophoretic particle according to the exemplary embodiment, the total content of the metal element (a calcium element or a magnesium element) deriving from the metal carbonate (a calcium carbonate or a magnesium carbonate) and the sodium element deriving from the sodium chloride is 0.1% by mass or less or about 0.1% by mass or less, preferably 0.05% by mass or less or about 0.05% by mass or less, and more preferably 0.02% by mass or less or about 0.02% by mass or less.

The measuring method of the content of each element is as follows, and the total content is found by adding the measured value of the content of each element.

Regarding a calcium element, a magnesium element and a sodium element, the strength of each element is measured with ICP emission spectrophotometer, and the content of each element is measured from the separately measured calibration curve.

The electrophoretic particle according to the exemplary embodiment is composed by containing the polymer of a polymerization component and a coloring agent, and, if necessary, other compounding materials. The electrophoretic particle may be a particle obtained by dispersing and blending a coloring agent in a polymer, or may be a particle obtained by covering or adhesion of a polymer on the surfaces of the particle of a coloring agent.

The polymer is described first.

As the polymer, polymers having a chargeable group (for example, a polarizable functional group, a polar group) are used. The polymer may be crosslinked with a crosslinking agent and the like.

As the polymer, a homopolymer of a polymerization component having a chargeable group, and a copolymer of a polymerization component having a chargeable group and a polymerization component not having a chargeable group are specifically exemplified.

These polymerization components may be used alone, or two or more kinds may be used in combination.

Here, as the chargeable group (a polar group, a polarizable functional group), a base and an acid group are exemplified.

The base as the chargeable group (hereinafter referred to as “a cationic group”) includes, for example, an amino group and a quaternary ammonium group (also including the salts of these groups). These cationic groups have a tendency to impart positive chargeable polarity to the particles.

The acid group as the chargeable group (hereinafter referred to as “an anionic group”) includes, for example, a phenol group, a carboxyl group, a carboxylate group, a sulfonic acid group, a sulfonate group, a phosphoric acid group, a phosphate group, and a tetraphenylboron group. These anionic groups have a tendency to impart negative chargeable polarity to the particles.

In addition to the above, a fluorine group, a phenyl group and a hydroxyl group can be also exemplified as the chargeable groups.

Each polymerization component is described below.

Incidentally, in the following description, “(meth)acrylate” means to include both “acrylate” and “methacrylate”.

As the polymerization components having a cationic group (hereinafter, referred to as a cationic polymerization component), the following are exemplified. Specifically, (meth)acrylates having an aliphatic amino group, such as N,N-dimethylaminoethyl(meth)acrylate, N,N-diethylaminoethyl(meth)acrylate, N,N-dibutylaminoethyl(meth)acrylate, N,N-hydroxyethylaminoethyl(meth)acrylate, N-ethylaminoethyl(meth)acrylate, N-octyl-N-ethylaminoethyl(meth)acrylate, and N,N-dihexylaminoethyl(meth)acrylate; aromatic substituted ethylene monomers having a nitrogen-containing group, such as dimethylaminostyrene, diethylaminostyrene, dimethylaminomethylstyrene, and dioctylaminostyrene; nitrogen-containing vinyl ether monomers, such as vinyl-N-ethyl-N-phenylaminoethyl ether, vinyl-N-butyl-N-phenylaminoethyl ether, triethanolamine divinyl ether, vinyl diphenyl aminoethyl ether, N-vinyl hydroxyethyl benzamide, and m-aminophenyl vinyl ether; pyrroles, such as vinylamine and N-vinylpyrrole; pyrrolines, such as N-vinyl-2-pyrroline and N-vinyl-3-pyrroline; pyrrolidines, such as N-vinylpyrrolidine, vinylpyrrolidine amino ether, and N-vinyl-2-pyrrolidone; imidazoles, such as N-vinyl-2-methylimidazole; imidazolines, such as N-vinylimidazoline; indoles, such as N-vinylindole; indulines, such as N-vinylindoline; carbazoles such as N-vinylcarbazole and 3,6-dibromo-N-vinylcarbazole; pyridines, such as 2-vinylpyridine, 4-vinylpyridine, and 2-methyl-5-vinylpyridine; piperidines, such as (meth)acrylpiperidine, N-vinylpiperidone, and N-vinylpiperazine; quinolines, such as 2-vinylquinoline and 4-vinylquinoline; pyrazoles, such as N-vinylpyrazole and N-vinylpyrazoline; oxazoles, such as 2-vinyloxazole; and oxazines, such as 4-vinyloxazine and morpholinoethyl(meth)acrylate are exemplified.

The cationic polymerization component may be formed into a quaternary ammonium salt by chloridization before or after polymerization. The quaternary ammonium salt is realized, for example, by the reaction of the cationic group with alkyl halides or tosylates.

As the polymerization components having an anionic group (hereinafter, referred to as an anionic polymerization component), for example, a polymerization component having a carboxylic acid group, a polymerization component having a sulfonic acid group, and a polymerization component having a phosphoric acid group are exemplified.

The examples of the polymerization components having a carboxylic acid group include, for example, (meth)acrylic acid, crotonic acid, itaconic acid, maleic acid, fumaric acid, citraconic acid, anhydrides thereof, monoalkyl esters thereof, vinyl ethers having a carboxyl group such as carboxyethyl vinyl ether, carboxypropyl vinyl ether, and salts thereof.

The examples of the polymerization components having a sulfonic acid group include, for example, styrenesulfonic acid, 2-acrylamido-2-methylpropanesulfonic acid, 3-sulfopropyl(meth)acrylic acid ester, bis(3-sulfopropyl)itaconic acid ester, and salts thereof. As the polymerization components having a sulfonic acid group besides the above, sulfuric monoester and a salt of 2-hydroxyethyl(meth)acrylic acid are also exemplified.

The examples of the polymerization components having a phosphoric acid group include, for example, vinylphosphonic acid, vinyl phosphate, acid phosphoxyethyl(meth)acrylate, acid phosphoxypropyl(meth)acrylate, bis(methacryloxyethyl)phosphate, diphenyl-2-methacryloyloxyethyl phosphate, diphenyl-2-acryloyloxyethyl phosphate, dibutyl-2-methacryloyloxyethyl phosphate, dibutyl-2-acryloyloxyethyl phosphate, and dioctyl-2-(meth)acryloyloxyethyl phosphate.

The anionic polymerization component may be formed into an ammonium salt by chloridization before or after polymerization. The ammonium salt is realized, for example, by the reaction of the anionic group with a tertiary amine or a quaternary ammonium hydroxide.

The examples of the polymerization components having a fluorine group include, for example, (meth)acrylate monomers having a fluorine atom. Specifically, trifluoroethyl(meth)acrylate, pentafluoropropyl(meth)acrylate, perfluoroethyl(meth)acrylate, perfluorobutylethyl(meth)acrylate, perfluorooctylethyl(meth)acrylate, perfluorodecylethyl(meth)acrylate, trifluoromethyltrifluoroethyl(meth)acrylate, and hexafluorobutyl(meth)acrylate are exemplified.

The examples of the polymerization components having a phenyl group include, for example, styrene, phenoxyethylene glycol (meth)acrylate, 2-hydroxy-3-phenoxypropyl(meth)acrylate, and phenoxyethylene glycol (meth)acrylate.

The examples of the polymerization components having a hydroxyl group include, for example, hydroxyalkyl(meth)acrylate (e.g., hydroxyethyl(meth)acrylate, hydroxypropyl(meth)acrylate), allyl alcohol, and polyethylene glycol mono(meth)acrylate. In addition to the above, those obtained by copolymerizing monomers having a glycidyl group and then ring opening, and those obtained by polymerizing monomers having a t-butoxy group and then hydrolyzing to introduce an OH group are also exemplified.

As the polymerization components not having a chargeable group, non-ionic polymerization components (nonionic polymerization components) are exemplified, for example, (meth)acrylonitrile, (meth)acrylic alkyl ester, (meth)acrylamide, ethylene, propylene, butadiene, isoprene, isobutylene, N-dialkyl-substituted (meth)acrylamide, vinyl carbazole, vinyl chloride, vinylidene chloride, isoprene, butadiene, and vinylpyrrolidone are exemplified.

The copolymerization ratio of the polymerization component (a monomer) having a chargeable group and the polymerization component (a monomer) not having a chargeable group is altered depending upon the quantity of charge of a desired particle. The copolymerization ratio of the polymerization component having a chargeable group and the polymerization component not having a chargeable group is generally selected in the range of 1/100 to 100/1 in a molar ratio.

The weight average molecular weight of the polymer is preferably 1,000 or more and 1,000,000 or less, and more preferably 10,000 or more and 200,000 or less.

The coloring agents are described in the next place.

As coloring agents, organic or inorganic pigments and oil-based dyes are exemplified. For example, magnetic powders, e.g., magnetite and ferrite, and known coloring agents, e.g., carbon black, titanium oxide, magnesium oxide, zinc oxide, phthalocyanine copper-based cyan coloring materials, azo-based yellow coloring materials, azo-based magenta coloring materials, quinacridone-based magenta coloring materials, red coloring materials, green coloring materials and blue coloring materials are exemplified. Specifically, Aniline Blue, Chalcoyl Blue, Chrome Yellow, Ultramarine Blue, Du Pont Oil Red, Quinoline Yellow, Methylene Blue Chloride, Phthalocyanine Blue, Malachite Green Oxalate, Lamp Black, Rose Bengal, C.I. Pigment Red 48:1, C.I. Pigment Red 122, C.I. Pigment Red 57:1, C.I. Pigment Yellow 97, C.I. Pigment Blue 15:1, and C.I. Pigment Blue 15:3 are representative coloring agents.

The compounding amount of a coloring agent is preferably 10% by mass or more and 99% by mass or less based on the polymer having a polar group (a chargeable group), and more preferably 30% by mass or more and 99% by mass or less.

Other compounding materials are described below.

As other compounding materials, for example, charge controlling materials and magnetic materials are exemplified.

As the charge controlling materials, well-known materials which are used as electrophotographic toner materials can be used, and the examples include cetylpyridyl chloride, quaternary ammonium salts, such as BONTRON P-51, BONTRON P-53, BONTRON E-84, and BONTRON E-81 (products manufactured by Orient Chemical Industries, Ltd.), salicylic acid-based metal complexes, phenol-based condensates, tetraphenyl-based compounds, metal oxide particles, and metal oxide particles having been subjected to surface treatment with various kinds of coupling agents.

As the magnetic materials, color-coated inorganic or organic magnetic materials are used according to necessity. Transparent magnetic materials, in particular, transparent organic magnetic materials hardly inhibit color development of coloring pigments and the specific gravity thereof is smaller as compared with inorganic magnetic materials, accordingly they are very preferably used.

As the colored magnetic materials (color-coated materials), for example, small particle size colored magnetic powder disclosed in JP-A-2003-131420 is exemplified. Colored magnetic materials containing magnetic particles as cores and colored layers laminated on the surfaces of the magnetic particles are used. As the colored layers, the magnetic particles may be coated with a pigment and the like opaquely, but it is preferred, for example, to use a light interference thin film. The light interference thin film is a thin film formed from a colorless material such as SiO₂ or TiO₂ and having a thickness equivalent to the wavelength of light, and selectively reflects the wavelength of light by light interference in the thin film.

The electrophoretic particle according to the exemplary embodiment may be a particle adhered with a polymer dispersant (e.g., bonding or covering) on the surfaces thereof. Further, a polymer dispersant having a chargeable group similar to the group of the polymer constituting the electrophoretic particle and the polymer dispersant may be used in place of the polymer constituting the electrophoretic particle.

As the polymer dispersant, a silicone-based polymer is representative. The silicone-based polymer is a polymer compound having a silicone chain, and more specifically, preferably a compound having a silicone chain (a silicone graft chain) as a side chain of the main chain of the main polymer compound.

As one example of the silicone-based polymers, a copolymer obtained by copolymerization of a polymerization component having a silicone chain and, according to necessity, at least one of a polymerization component having a reactive group, a polymerization component having a chargeable group, and a polymerization component not having a chargeable group is preferably exemplified. Incidentally, as the materials of the copolymerization components in the copolymer (in particular, the polymerization component having a silicone chain), a monomer may be used or a macromonomer may be used. “Macromonomer” is a general term for an oligomer (degree of polymerization of about 2 to 300) or a polymer having a polymerizable functional group, which has both properties of a polymer and a monomer.

As the polymerization components having a silicone chain, dimethyl silicone monomers having a (meth)acrylate group on one terminal (for example, SILAPLANE FM-0711, FM-0721, FM-0725 (manufactured by Chisso Corporation), and X-22-174DX, X-22-2426, X-22-2475 (manufactured by Shin-Etsu Chemical Co., Ltd.) are exemplified.

As the polymerization components having a reactive group, glycidyl(meth)acrylate having an epoxy group, and isocyanate-based monomers having an isocyanate group (KARENZ AOI and KARENZ MOI (manufactured by Showa Denko K.K.) are exemplified.

As the polymerization components having a chargeable group and other polymerization components (polymerization components not having a chargeable group), the polymerization components having a chargeable group and the polymerization components not having a chargeable group exemplified in the above description of the polymers having a chargeable group are applied.

In the silicone-based polymer, the polymerization component having a silicone chain accounting for in the total polymerization components is 3% or more and 60% or less in a mass ratio, and preferably 5% or more and 40% or less.

As the silicone polymers, besides the above copolymers, a silicone compound having an epoxy group on one terminal (a silicone compound represented by the following structural formula (1)) is also exemplified. As the silicone compounds having an epoxy group on one terminal, for example, X-22-173DX (manufactured by Shin-Etsu Chemical Co., Ltd.) is exemplified.

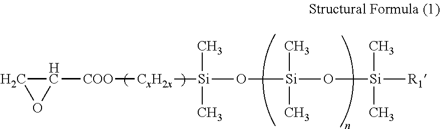

In structural formula (1), R₁′ represents a hydrogen atom or an alkyl group having 1 to 4 carbon atoms; n represents a natural number (e.g., 1 or more and 1,000 or less, and preferably 3 or more and 100 or less), and x represents an integer of 1 to 3.

As the silicone polymers, copolymers containing at least two components of a dimethyl silicone monomer having a (meth)acrylate group on one terminal (a silicone compound represented by the following structural formula (2), for example, SILAPLANE FM-0711, FM-0721, FM-0725 (manufactured by Chisso Corporation), and X-22-174DX, X-22-2426, X-22-2475 (manufactured by Shin-Etsu Chemical Co., Ltd.)) and a glycidyl(meth)acrylate or isocyanate monomer (KARENZ AOI, KARENZ MOI, manufactured by Showa Denko K.K.) are also preferably exemplified.

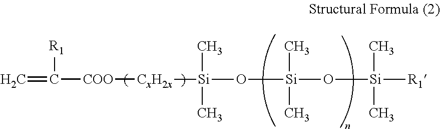

In structural formula (2), R₁ represents a hydrogen atom or a methyl group; R₁′ represents a hydrogen atom or an alkyl group having 1 to 4 carbon atoms; n represents a natural number (e.g., 1 or more and 1,000 or less, and preferably 3 or more and 100 or less), and x represents an integer of 1 to 3.

The weight average molecular weight of the silicone-based polymer is preferably 500 or more and 1,000,000 or less, and more preferably 1,000 or more and 1,000,000 or less.

The average particle size (the volume average particle size) of the electrophoretic particles according to the exemplary embodiment is, for example, 0.1 μm or more and 20 μm or less, but the average particle size is selected depending upon the use and not restricted thereto.

The average particle size is measured with PHOTAL FPAR-1000 (a dynamic light scattering particle size distribution measuring apparatus, manufactured by Otsuka Electronics Co., Ltd.), and analyzed by MARQUARDT method. The measurement may also be performed with LA300 (a laser diffraction scattering system particle size distribution measuring apparatus, manufactured by Horiba Seisakusho Co., Ltd.).

The manufacturing method of the electrophoretic particle according to the exemplary embodiment will be described.

The manufacturing method of the electrophoretic particle according to the exemplary embodiment is a method of obtaining the particle by suspending a polymerization component (a polymerization component for forming a polymer), a coloring agent, metal carbonate and sodium chloride in an aqueous phase and then polymerizing the polymerization component.

A specific method is described below.

In the first place, a first dispersion liquid is prepared by mixing a polymerization component, a coloring agent and, if necessary, other compounding material (e.g., a polymerization initiator or a crosslinking agent) with a solvent, according to necessity.

As the solvents, for example, aliphatic hydrocarbon solvents (e.g., n-pentane, n-hexane, n-butane), alicyclic hydrocarbon solvents (e.g., methylcyclopentane, cyclohexane), and mixtures of these solvents are exemplified.

On the other hand, a second dispersion liquid is prepared by mixing metal carbonate, sodium chloride, water and, if necessary, other compounding material. Specifically, for example, an aqueous dispersion liquid is prepared by dispersing the metal carbonate while pulverizing in water, and mixing with an aqueous dispersion liquid (brine) wherein sodium chloride is dissolved, to obtain a second dispersion liquid.

Subsequently, a suspension liquid is prepared by mixing the first dispersion liquid and the second dispersion liquid and emulsifying the mixture in an aqueous phase.

In the next place, the suspension is heated and the polymerization component is polymerized in an aqueous phase in the presence of the metal carbonate and sodium chloride, thus electrophoretic particle composed by containing the polymer of the polymerization component and the coloring agent are formed.

After that, the formed electrophoretic particle is subjected to a washing process. By being subjected to the washing process, the total content of the metal element deriving from metal carbonate (a calcium element or a magnesium element) and sodium chloride is reduced to the above range.

Specifically, it is preferred to perform a washing process by combining the following methods.

1) A method of decomposing the metal carbonate with an acid aqueous solution (e.g., aqueous solution of hydrochloric acid)
2) A method of washing with washing water (e.g., distilled water, ion exchange water)
3) A method of using an ion exchange resin in washing with washing water
4) A method by heat stirring (e.g., stiffing while heating at 30° C. to 80° C.) in washing with washing water

There are two kinds of ion exchange resins of the anion exchange resin and the cation exchange resin, and the cation exchange resin is effective for the removal of metal ions. However, when there is the possibility of the occurrence of hydrolysis of the polymer due to too high acidity of the cation exchange resin, a mixture of the cation exchange resin and the anion exchange resin may be used as the ion exchange resin.

As ion exchange resins, cation exchange resins, such as AMBERLITE 15, AMBERLITE 200C, AMBERLYST 15E (products manufactured by Rohm & Haas), DOWEX MWC-1-H, DOWEX 88, DOWEX HCR-W2 (products manufactured by The Dow Chemical Company), LEWATIT SPC-108, LEWATIT SPC-118 (products manufactured by Lanxess AG), DIAION RCP-150H (a product manufactured by Mitsubishi Kasei Corporation), SUMIKAION KC-470, DUOLITE C26-C, DUOLITE C-433, DUOLITE 464 (products manufactured by Sumitomo Chemical Co., Ltd.), and NAFION-H (manufactured by E.I. Du Pont de Nemours & Co., Inc.), and anion exchange resins, such as AMBERLITE IRA-400 and AMBERLITE IRA-45 (products manufactured by Rohm & Haas) are exemplified.

The amount of the ion exchange resin is selected according to the amount of the metal ions to be removed.

The electrophoretic particle according to the exemplary embodiment is obtained through the above processes.

### [Electrophoretic Particle Dispersion Liquid]

The electrophoretic particle dispersion liquid according to the exemplary embodiment contains a dispersion medium and an electrophoretic particle dispersed in the dispersion medium, which contains the electrophoretic particle according to the exemplary embodiment.

A dispersion medium is not especially restricted, but it is preferred to be selected from among solvents having a low dielectric constant (for example, a dielectric constant of 5.0 or less, and preferably 3.0 or less). Solvents other than the solvents having a low dielectric constant may be used in combination as a dispersion medium, but it is preferred to contain 50% by volume or more of a low dielectric constant solvent. Dielectric constant of a low dielectric constant solvent can be found with a dielectric constant meter (manufactured by Nihon Rufuto Co., Ltd.).

As a solvent having a low dielectric constant, for example, solvents having a high boiling temperature deriving from petroleum, such as paraffin-based hydrocarbon solvent, silicone oil and fluorine-based liquid are exemplified, and silicone oil is preferable.

As silicone oils, silicone oils in which a hydrocarbon group is bonded to a siloxane bond (e.g., dimethyl silicone oil, diethyl silicone oil, methylethyl silicone oil, methylphenyl silicone oil, and diphenyl silicone oil) are specifically exemplified. Of these silicone oils, dimethyl silicone oil is especially preferred.

As paraffin-based hydrocarbon solvents, n-paraffin-based hydrocarbon having 20 or more carbon atoms (having a boiling temperature of 80° C. or more) and isoparaffin-based hydrocarbon are exemplified. In view of safety and volatility, it is preferred to use isoparaffin. Specifically, SHELLSOL 71 (manufactured by Shell Oil Co.), ISOPAR O, ISOPAR H, ISOPAR K, ISOPAR L, ISOPAR G, and ISOPAR M (ISOPAR is the trade name of Exxon Chemical Corp.), and IP Solvent (manufactured by Idemitsu Petrochemical Co., Ltd.) are exemplified.

To the electrophoretic particle dispersion liquid according to the exemplary embodiment, if necessary, acid, alkali, salt, a dispersant, a dispersion stabilizer, in addition, a stabilizer, an antibacterial agent and an antiseptic for the purpose of prevention of oxidation and ultraviolet absorption may be added. Further, a charge controlling agent may be added to the electrophoretic particle dispersion liquid according to the exemplary embodiment.

The concentration of the electrophoretic particle in the electrophoretic particle dispersion liquid according to the exemplary embodiment is variously selected depending upon display characteristics and response characteristics, but it is preferably selected in the range of 0.1% by mass or more and 30% by mass or less. When particles different in colors are mixed, the gross of the particles is preferably within this range.

The electrophoretic particle dispersion liquid according to the exemplary embodiment is used for a display medium of electrophoretic system, a light-modulating medium (a light-modulating device) of electrophoretic system, and a liquid toner of liquid development type electrophotographic system. Incidentally, as the display medium of electrophoretic system and a light-modulating medium (a light-modulating device) of electrophoretic system, there are a well-known system of moving the particle group in the direction opposite to the electrode (substrate), a system of moving in the direction along the electrode (substrate) (what is called an in-plane system) different from the above, and a hybrid device of combining these systems.

In the electrophoretic particle dispersion liquid according to the exemplary embodiment, color display is realized by using a plurality of kinds of electrophoretic particles different in colors and charge polarities as mixture.

### [Display Medium and Display Device]

One example of display medium and display device according to the exemplary embodiment will be described below.

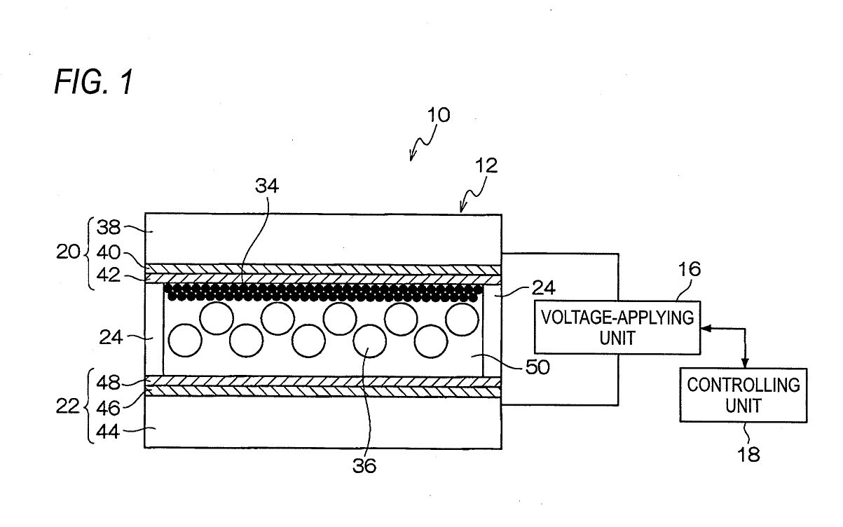

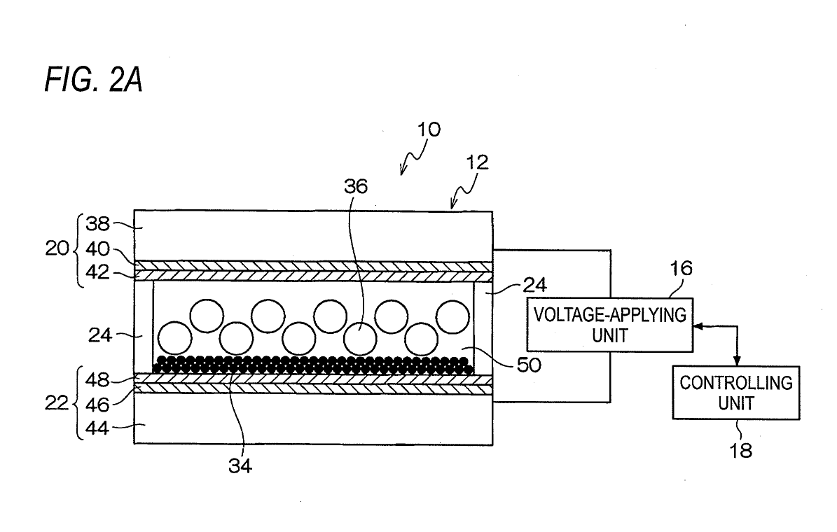

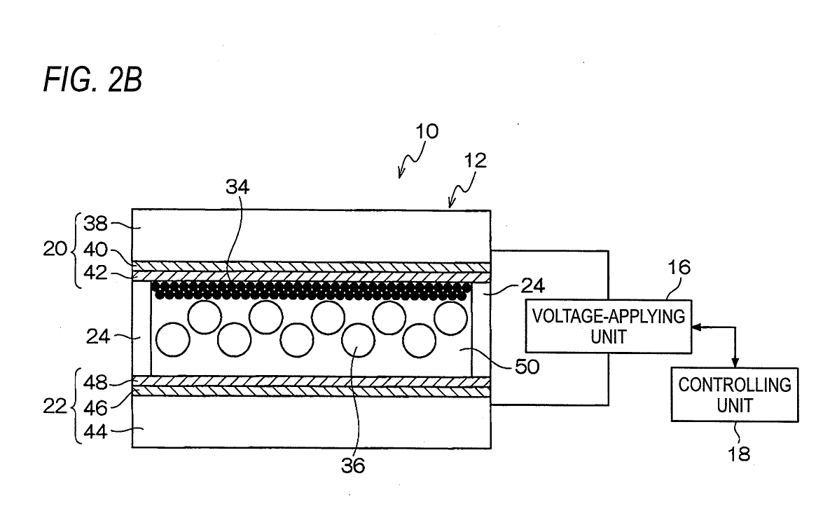

FIG. 1 is a schematic drawing of the display device according to the exemplary embodiment. FIGS. 2A and 2B are drawings typically showing the moving modes of the particles at the time when voltage is applied to between the substrates of the display medium of the display device according to the exemplary embodiment.

The display device 10 according to the exemplary embodiment takes the form of using the electrophoretic particle dispersion liquid according to the exemplary embodiment as the particle dispersion liquid of the display medium 12 containing the dispersion medium 50 and the particle group 34, that is, the form of dispersing the electrophoretic particles according to the exemplary embodiment as the particle group 34 in the dispersion medium 50.

As shown in FIG. 1, the display device 10 according to the exemplary embodiment is composed of the display medium 12, the voltage applying unit 16 that applies a voltage to the display medium 12, and the controlling unit 18.

The display medium 12 is composed of the display substrate 20 which is an image display face, the rear substrate 22 facing the display substrate 20 with a space, the spacing member 24 for maintaining the space between these substrates of a specific interval and also dividing the space between the display substrate 20 and the rear substrate 22 to a plurality of cells, and the reflecting particle group 36 having optical reflection characteristic different from that of the particle group 34 enclosed in each cell.

The above cell means a region surrounded with the display substrate 20, the rear the substrate 22 and the spacing member 24. The dispersion medium 50 is enclosed in the cell. The particle group 34 is composed of a plurality of particles and dispersed in the dispersion medium 50 and the plurality of particles move between the display substrate 20 and the rear substrate 22 through space between the reflecting particle group 36 according to the electric field intensity formed in the cell.

The display medium 12 may be constituted so as to perform display of every pixel by forming the spacing member 24 to correspond to each pixel at the time of displaying an image on the display medium 12 and forming a cell to correspond to each pixel.

In the exemplary embodiment, for simplifying explanation, the exemplary embodiment is described by attracting attention to one cell. Each constituent is described in detail below.

First, a pair of electrodes will be explained.

The display substrate 20 has a constitution where the surface electrode 40 and the surface layer 42 are laminated on the supporting substrate 38 in this order. The rear substrate 22 has a constitution where, on the supporting substrate 44, the rear electrode 46 and the surface layer 48 are laminated.

The display substrate 20, or both the display substrate 20 and the rear substrate 22 have light transmitting property. The light transmitting property in the exemplary embodiment means the transmittance of visible light of 60% or more.

As the materials of the supporting substrate 38 and the supporting substrate 44, glass, and plastics, such as a polyethylene terephthalate resin, a polycarbonate resin, an acrylic resin, a polyimide resin, a polyester resin, an epoxy resin, and a polyether sulfone resin are exemplified.

As the materials of the surface electrode 40 and the rear electrode 46, oxides of indium, tin, cadmium, and antimonyl, complex oxides, such as ITO, metals, such as gold, silver, copper, and nickel, and organic materials, such as polypyrrole and polythiophene are exemplified. The surface electrode 40 and the rear electrode 46 may be any of single films, mixed films and complex films of these materials. The thickness of the surface electrode 40 and the rear electrode 46 is preferably 100 Å or more and 2,000 Å or less. The rear electrode 46 and the surface electrode 40 may be formed in the state of matrix or stripe.

The surface electrode 40 may be buried in the supporting substrate 38. Further, the rear electrode 46 may be buried in the supporting substrate 44. In such a case, the materials of the supporting substrate 38 and the supporting substrate 44 are selected according to the composition of each particle of the particle group 34.

Each of the rear electrode 46 and the surface electrode 40 may be separated from the display substrate 20 and the rear substrate 22 and arranged on the outside of the display medium 12.

In the above explanation, both of the display substrate 20 and the rear substrate 22 are provided with an electrode (surface electrode 40 and rear electrode 46), but an electrode may be provided on one side, and active matrix driving may be performed.

For performing active matrix driving, the supporting substrate 38 and the supporting substrate 44 may be provided with TFT (thin film transistor) on every pixel. It is preferred to provide TFT on the rear substrate 22 not on the display substrate 20.

The surface layer is described below.

The surface layer 42 and the surface layer 48 are formed on the surface electrode 40 and the rear electrode 46, respectively. As the materials for forming the surface layer 42 and the surface layer 48, for example, polycarbonate, polyester, polystyrene, polyimide, epoxy, polyisocyanate, polyamide, polyvinyl alcohol, polybutadiene, polymethyl methacrylate, copolymerized nylon, UV-curable acrylic resin and fluorine resin are exemplified.

The surface layer 42 and the surface layer 48 may be composed of the above resin and charge-transporting material, or may be formed of a self-supporting resin having charge-transporting property.

Next, the spacing member is described below.

The spacing member 24 for maintaining the space between the display substrate 20 and the rear substrate 22 is formed of, for example, a thermoplastic resin, a thermosetting resin, an electron bean-curable resin, a photo-curable resin, rubber or metal.

The spacing member 24 may be integrated into either the display substrate 20 or the rear substrate 22. In such a case, integration is performed by etching treatment for etching the supporting substrate 38 or the supporting substrate 44, laser treatment, press treatment using a die prepared in advance, or printing treatment.

In this case, the spacing member 24 is manufactured on either or both of the display substrate 20 and the rear substrate 22.

The spacing member 24 may be colored or colorless, but is preferably colorless and transparent. In such a case a transparent resin such as polystyrene, polyester or acryl is used.

It is preferred that the spacing member 24 in a particulate state is also transparent, and in addition to transparent resin, e.g., polystyrene, polyester or acrylic resin, glass particles are also used.

“Transparent” means to have the transmittance of visible light of 60% or more.

The reflecting particle group is described below.

The reflecting particle group 36 is composed of reflecting particles having optical reflection characteristic different from that of the particle group 34, and functions as a reflecting member of displaying different color from that of the particle group 34. The reflecting particle group 36 also has a function as a spacing member of moving particles between the display substrate 20 and the rear substrate 22 with no inhibition. That is, particles of the particle group 34 are moved from the side of the rear substrate 22 to the side of the display substrate 20, or from the side of the display substrate 20 to the side of the rear substrate 22 through the reflecting particle group 36. The color of the reflecting particle group 36 is preferably white or black as a background color, but may be other colors. The reflecting particle group 36 may be a non-charged particle group (particle group not moving according to electric field), or may be a charged particle group (particle group moving according to electric field). In the exemplary embodiment, the reflecting particle group 36 in the case of non-charged particle group and white in color is described, but not limitative.

As the particles of the reflecting particle group 36, particles obtained by dispersing a white pigment (e.g., titanium oxide, silicon oxide, zinc oxide) in a resin (e.g., polystyrene resin, polyethylene resin, polypropylene resin, polycarbonate resin, polymethyl methacrylate resin (PMMA), acrylic resin, phenol resin, formaldehyde condensate), or resin particles (e.g., polystyrene particles, polyvinyl naphthalene particles, bis-melamine particles) are exemplified. When particles other than white particles are applied to the particles of the reflecting particle group 36, the above resins including a pigment or dye of a desired color may be used. Pigments or dyes of RGB and YMC generally used in printing inks or color toners are exemplified.

For enclosing the reflecting particle group 36 between substrates, for example, in inkjet method is used. In the case of fixing the reflecting particle group 36, the reflecting particle group 36 is enclosed and then heated (if necessary, by pressing) to melt the surface layers of the particles of the reflecting particle group 36, while maintaining the spaces of the particles.

Other constitutions of the display medium are described below.

The size of the cell in the display medium 12 is closely related to the resolution of the display medium 12. The smaller the size of cell, the higher is the resolution of the image displayed on the display medium 12. Generally the length of the cell in the face direction of the display substrate 20 of the display medium 12 is 10 μm or more and 1 mm or less.

The content of the particle group 34 (% by mass) based on the gross mass in the cell is not especially restricted so long as a desired hue can be obtained. As the display medium 12, it is effective to adjust the content by the thickness of the cell (the distance between the display substrate 20 and the rear substrate 22). That is, for obtaining a desired hue, the thicker the cell, the smaller is the content, and the thinner the cell, the larger can be the content. Generally, the content is 0.01% by mass or more and 50% by mass or less.

For fixing the display substrate 20 and the rear substrate 22 to each other through the spacing member 24, fixing units such as a combination of bolt and nut, clamp, clip, a frame for fixing are used. Fixing units such as an adhesive, heat melting and ultrasonic binding may also be used.

The display medium 12 thus constituted is used, for example, for a bulletin board on which images are preserved and rewritten, a circular bulletin, an electronic blackboard, an advertisement, a signboard, a flasher indicator, electronic paper, electronic newspaper, electronic publication and document sheets common to copier and printer.

As described above, the display device 10 according to the exemplary embodiment is composed of the display medium 12, the voltage applying unit 16 that applies a voltage to the display medium 12, and the controlling unit 18 (refer to FIG. 1).

The surface electrode 40 and the rear electrode 46 are electrically connected to the voltage applying unit 16. In the exemplary embodiment, the case where both the surface electrode 40 and the rear electrode 46 are electrically connected to the voltage applying unit 16 is described, but one of the surface electrode 40 and the rear electrode 46 may be connected to the earth and the other may be connected to the rear electrode 46.

The voltage applying unit 16 is connected to the controlling unit 18 in a manner such that signals are delivered and received.

The controlling unit 18 is constituted as a micro-computer containing CPU (Central Processing Unit) for governing the actuation of the device as a whole, RAM (Random Access Memory) for memorizing various data temporarily, and ROM (Read Only Memory) where various programs such as a control program for controlling the device at large are memorized in advance.

The voltage applying unit 16 is a voltage applying device for applying a voltage to the surface electrode 40 and the rear electrode 46, which applies the voltage to the surface electrode 40 and the rear electrode 46 according to the control of the controlling unit 18.

The function of the display device 10 is described below. The function is explained according to the actuation of the controlling unit 18.

The case where the particle group 34 enclosed in the display medium 12 is charged to positive electrode is described. Further, the case where the dispersion medium 50 is transparent and the reflecting particle group 36 is colored in white is explained. That is, in the exemplary embodiment, the case where the display medium 12 displays the color shown by the movement of the particle group 34, and the reflecting particle group 36 shows white as the background color is explained.

For convenience's sake, the actuation from the time when the particle group 34 attached to the side of the rear substrate 22 is described.

In the first place, actuation signal to show to apply a voltage so that the surface electrode 40 becomes negative electrode and the rear electrode 46 becomes positive electrode is output to the voltage applying unit 16 for prescribed time. From the state shown in FIG. 2A, when the voltage applied to between the electrodes is increased and the voltage over the threshold voltage by which the surface electrode 40 is negative electrode and concentration variation is finished is applied, the particles constituting the particle group 34 charged to positive electrode move to the side of the display substrate 20 and arrives on the display substrate 20 in the state of aggregation force being reduced (refer to FIG. 2B).

When application of voltage to between electrodes is finished, the particle group 34 is restrained on the side of the display substrate 20, and the color exhibited by the particle group 34 is visually confirmed as the color of the display medium 12 which is viewed from the display substrate 20 with white of the color of the reflecting particle group 36 as the background.

In the next place, actuation signal to show to apply a voltage so that the surface electrode 40 becomes positive electrode and the rear electrode 46 becomes negative electrode is output to the voltage applying unit 16 for prescribed time. When the voltage applied to between the electrodes is increased and the voltage over the threshold voltage by which the surface electrode 40 is positive electrode and concentration variation is finished is applied, the particles constituting the particle group 34 charged to positive electrode move to the side of the display substrate 20 and arrive on the display substrate 20 in the state of aggregation force being reduced (refer to FIG. 2A).

When application of voltage to between electrodes is finished, the particle group 34 is restrained on the side of rear substrate 22. On the other hand, white as the color of the reflecting particle group 36 is visually confirmed as the color of display medium 12 which is viewed from the display substrate 20. The particle group 34 is hidden by the reflecting particle group 36 and becomes difficult to be visually confirmed.

The voltage application time is memorized in advance in memory such as ROM as the data for showing voltage application time in voltage application in actuation, drawing of the inside of the controlling unit 18 is omitted. The data showing voltage application time is read at the time of run.

Thus, in the display device 10 according to the exemplary embodiment, display is carried out when the particle group 34 arrives on and is attached to the display substrate 20 or the rear substrate 22, and aggregates.

In the display medium 12 and the display device 10 according to the exemplary embodiment, the form of providing the surface electrode 40 on the display substrate 20 and the rear electrode 46 on the rear substrate 22 to apply voltage to between the electrodes (i.e., between the substrates) and moving the particle group 34 between the substrates to perform display is described, but not restricted thereto. For example, a form of providing the surface electrode 40 on the display substrate 20, while providing an electrode on the spacing member, applying voltage to between the electrodes, moving the particle group 34 between the display substrate 20 and the spacing member to thereby effect display is also possible.

In the display medium 12 and the display device 10 according to the exemplary embodiment, the case of using one kind (one color) of the particle group as the particle group 34 is described, but not limitative, and two or more kinds (two or more colors) of particle groups may be applied.

Specifically, for example, the form of using positively chargeable first particle group and negatively chargeable second particle group as the particle group 34, and positively chargeable third particle group having threshold voltage different from that of the particles of the first particle group, and having a larger particle size is exemplified.

### EXAMPLE

The invention will be described in further detail with reference to examples, but the invention is by no means restricted thereto. In the examples “parts” and “%” mean “parts by mass” and “% by mass” unless otherwise indicated.

### Example A

### Example A1

### Preparation of Dispersion Liquid AA

Dispersion liquid AA is prepared by mixing the following components and pulverizing the mixture in a ball mill with 10 mmφ zirconia balls for 20 hours.

<Composition>

| | |
|---|---|
| Methyl methacrylate | 44.5 parts by mass |
| 2-(Diethylamino)ethyl methacrylate | 0.5 parts by mass |
| Red pigment (Pigment Red 3090 | 5 parts by mass |
| (manufactured by Sanyo Color Works Ltd.) | |

### Preparation of Dispersion Liquid AB

Dispersion liquid AB is prepared by mixing the following components and finely pulverizing with a ball mill in the similar manner to the above.

<Composition>

| | |
|---|---|
| Calcium carbonate | 40 parts by mass |
| Water | 60 parts by mass |

### Preparation of Mixed Liquid AC

Mixed liquid AC is prepared by mixing the following components, deaerating the mixture with an ultrasonic deaerator for 10 minutes, and stirring with an emulsifier.

<Composition>

| | |
|---|---|
| Dispersion liquid AB | 4 g |
| Brine of 20% by mass | 60 g |

Dispersion liquid AA (30 g), 0.6 g of ethylene glycol dimethacrylate and 0.3 g of a polymerization initiator V-601 (manufactured by Wako Pure Chemical Industries) are weighed out and thoroughly mixed, and the mixture is subjected to deaeration with an ultrasonic deaerator for 10 minutes. The obtained solution is added to mixed liquid AC, and emulsified with an emulsifier, thus a suspension is prepared.

The suspension is put in a bottle and the bottle is stoppered with a silicone stopper. Deaeration under reduced pressure is carried out sufficiently with a needle of an injector and the suspension is enclosed with nitrogen gas. Particles are prepared by the succeeding reaction at 60° C. for 10 hours.

After then, the obtained particles are subjected to the following washing process 11) 2 times, and then to washing process 12) 1 time.

11) A washing process of dispersing the obtained particles in ion exchange water, decomposing the calcium carbonate with an aqueous solution of hydrochloric acid, and then filtering the particles;

12) A washing process of, after the treatment with the aqueous solution of hydrochloric acid, adding the obtained particles to an ion exchange liquid in which an ion exchange resin (AMBERLITE 15, manufactured by Rohm & Haas) is dispersed (the content of the ion exchange resin is 10% by mass to the particles to be added), washing the particles while heat stirring at 50° C., and then filtering

In the next place, after the washing processes, the obtained particles are passed through a nylon sieve having an aperture size of 15 μm and 10 μm to make the particle size uniform. The obtained particles have a volume average particle size of 13 μm. After then, the particles are washed with methanol and dried under reduced pressure to thereby obtain red particles.

### Examples A2 to A4

Red particles are prepared in the same manner as in Example A1, except for changing the conditions of washing processes according to Table 1.

### Examples A5 to A7

Red particles are prepared in the same manner as in Example A1, except for changing the methyl methacrylate used in Example A1 to cyclohexyl methacrylate and the conditions of washing processes according to Table 1.

### Comparative Example A1

Red particles are prepared in the same manner as in Example A1, except for changing the conditions of washing processes according to Table 1.

### Example B

### Example B1

### Preparation of Dispersion Liquid BA

Dispersion liquid BA is prepared by mixing the following components and pulverizing the mixture in a ball mill with 10 mmφ zirconia balls for 20 hours.

<Composition>

| | |
|---|---|
| Methyl methacrylate | 44.5 parts by mass |
| 2-(Diethylamino)ethyl methacrylate | 0.5 parts by mass |
| Red pigment (Pigment Red 30906 | 5 parts by mass |
| (manufactured by Sanyo Color Works Ltd.) | |

### Preparation of Dispersion Liquid BB

Dispersion liquid BB is prepared by mixing the following components and finely pulverizing with a ball mill in the similar manner to the above.

<Composition>

| | |
|---|---|
| Magnesium carbonate | 40 parts by mass |
| Water | 60 parts by mass |

### Preparation of Mixed Liquid BC

Mixed liquid BC is prepared by mixing the following components, deaerating the mixture with an ultrasonic deaerator for 10 minutes, and stirring with an emulsifier.

<Composition>

| | |
|---|---|
| Dispersion liquid BB | 4 g |
| Brine of 20% by mass | 60 g |

Dispersion liquid BA (30 g), 0.6 g of ethylene glycol dimethacrylate and 0.3 g of a polymerization initiator V-601 (manufactured by Wako Pure Chemical Industries) are weighed out and thoroughly mixed, and the mixture is subjected to deaeration with an ultrasonic deaerator for 10 minutes. The obtained solution is added to mixed liquid BC, and emulsified with an emulsifier, thus a suspension is prepared.

The suspension is put in a bottle and the bottle is stoppered with a silicone stopper. Deaeration under reduced pressure is carried out sufficiently with a needle of an injector and the suspension is enclosed with nitrogen gas. Particles are prepared by the succeeding reaction at 60° C. for 10 hours.

After then, the obtained particles are subjected to the following washing process 21) 2 times, and then to washing process 22) 1 time.

21) A washing process of dispersing the obtained particles in ion exchange water, decomposing the magnesium carbonate with an aqueous solution of hydrochloric acid, and then filtering the particles;

22) A washing process of, after the treatment with the aqueous solution of hydrochloric acid, adding the obtained particles to an ion exchange liquid in which an ion exchange resin (AMBERLITE 15, manufactured by Rohm & Haas) is dispersed (the content of the ion exchange resin is 10% by mass to the particles to be added), washing the particles while heat stirring at 50° C., and then filtering

In the next place, after the washing processes, the obtained particles are passed through a nylon sieve having an aperture size of 15 μm and 10 μm to make the particle size uniform. The obtained particles have a volume average particle size of 13 μm. After then, the particles are washed with methanol and dried under reduced pressure to thereby obtain red particles.

### Examples B2 to B4

Red particles are prepared in the same manner as in Example B1, except for changing the conditions of washing processes according to Table 2.

### Examples B5 to B7

Red particles are prepared in the same manner as in Example B1, except for changing the methyl methacrylate used in Example B1 to cyclohexyl methacrylate and the conditions of washing processes according to Table 2.

### Comparative Example B1

Red particles are prepared in the same manner as in Example B1, except for changing the conditions of washing processes according to Table 2.

### EVALUATION

### (Manufacture of Cell for Evaluation)

Two substrates having the same surface layer are prepared and they are taken as the first substrate and second substrate. The second substrate is put upon the first substrate so as to face to each surface layer with a Teflon (registered trademark) sheet of a thickness of 50 μm as the spacer and clasped with a clip.

Subsequently, white particles and red particles obtained in each example are regulated so that the concentrations of respective particles become 25% by mass and 10% by mass with silicone oil (KF-96L-2CS, manufactured by Shin-Etsu Chemical Co., Ltd.), and injected into the space between the above substrates and sealed to make the cell for evaluation.

The white particles are manufactured as follows.

### (Manufacture of White Particles)

Into a three-necked flask having a capacity of 100 ml equipped with a reflux condenser are put 5 parts by mass of 2-vinylnaphthalene, 5 parts by mass of SILAPLANE FM-0721 (a straight chain silicone monomer, weight average molecular weight: 5,000, manufactured by Chisso Corporation), 0.3 parts by mass of lauroyl peroxide (a polymerization initiator, manufactured by Wako Pure Chemical Industries), and 20 parts by mass of dimethyl silicone oil (KF-96L-1CS, manufactured by Shin-Etsu Chemical Co., Ltd.), and bubbling by nitrogen gas is performed for 15 minutes. After that, polymerization is carried out at 65° C. for 24 hours under a nitrogen atmosphere. The obtained white particles are precipitated with a centrifugal separator, diluted with silicone oil (KF-96L-2CS, manufactured by Shin-Etsu Chemical Co., Ltd.) and the concentration of the solid content is adjusted to 33% by mass to prepare a white particle dispersion liquid. The volume average particle size of the white particles is 0.45 μm.

### (Content of Each Element)

The red particles obtained in each example are used as a measuring sample, and contents of the calcium element (Ca), magnesium element (Mg) and sodium element (Na) are measured by the above-described method.

The results obtained are shown in Table 1.

### (Stability of Display Repetition)

The stability of display repetition is evaluated by using the cell for evaluation as follows.

By using the cell for evaluation, voltage of 15 V is applied to both electrodes for 1 second so that the second substrate becomes plus. Red particles migrate to the electrode on the minus side, that is, the first substrate side, and white color is observed when viewed from the second substrate side (operation 1).

After then, voltage of 15 V is applied to both electrodes for 1 second so that the second substrate becomes minus. Red particles migrate to the electrode on the minus side, that is, the second substrate side, and red color is observed as display color when viewed from the second substrate side (operation 2).

At this time, after applying voltage of 15 V for 1 second so that the second substrate side becomes minus, voltage is cut off, and then voltage is gradually raised so that the second substrate side becomes plus, and voltage at the time when white color is observed is taken as the initial threshold value.

After repeating operation 1 and operation 2 one thousand times, the threshold value after repetition is measured similarly, and the stability of display repetition is evaluated from the difference between the initial threshold value and the threshold value after repetition.

The criteria of evaluation are as follows. The results are shown in Table 1 below.

G5: The difference in the threshold values is less than 3 V.
G4: The difference in the threshold values is less than 5 V.
G3: The difference in the threshold values is less than 10 V.
G2: The difference in the threshold values is less than 15 V.
G1: The difference in the threshold values is 15 V or more.

TABLE 1

| | | Ca | Na | Ca + Na | Stability of |
|---|---|---|---|---|---|
| Example | | Content | Content | Content | Display |
| No. | Washing Process | (% by mass) | (% by mass) | (% by mass) | Repetition |
| Example A1 | 11) Washing process: two times | 0.008 | 0.022 | 0.030 | G5 |
| | 12) Washing process: one time | | | | |
| Example A2 | 11) Washing process: five times | 0.003 | 0.015 | 0.018 | G5 |
| | 12) Washing process: two times | | | | |
| Example A3 | 11) Washing process: two times | 0.031 | 0.031 | 0.065 | G4 |
| | 12) Washing process: one time | | | | |
| | (without heat stiffing) | | | | |
| Example A4 | 11) Washing process: two times | 0.019 | 0.020 | 0.039 | G4 |
| | 12) Washing process: one time | | | | |
| | (ion exchange resin is replaced | | | | |
| | with Amberlite 200C) | | | | |
| Example A5 | 11) Washing process: two times | 0.012 | 0.030 | 0.042 | G4 |
| | 12) Washing process: one time | | | | |
| Example A6 | 11) Washing process: five times | 0.005 | 0.011 | 0.016 | G5 |
| | 12) Washing process: two times | | | | |
| Example A7 | 11) Washing process: two times | 0.056 | 0.030 | 0.086 | G3 |
| | 12) Washing process: one time | | | | |
| | (without heat stiffing) | | | | |
| Comparative | 11) Washing process: one time | 0.110 | 0.021 | 0.131 | G1 |
| Example A1 | 12) Washing process: None | | | | |

TABLE 2

| | | Mg | Na | Mg + Na | Stability of |
|---|---|---|---|---|---|
| | | Content | Content | Content | Display |
| Example No. | Washing Process | (% by mass) | (% by mass) | (% by mass) | Repetition |
| Example B1 | 21) Washing process: two times | 0.017 | 0.020 | 0.037 | G5 |
| | 22) Washing process: one time | | | | |
| Example B2 | 21) Washing process: five times | 0.003 | 0.016 | 0.019 | G5 |
| | 22) Washing process: two times | | | | |
| Example B3 | 21) Washing process: two times | 0.030 | 0.031 | 0.061 | G4 |
| | 22) Washing process: one time | | | | |
| | (without heat stiffing) | | | | |
| Example B4 | 21) Washing process: two times | 0.025 | 0.021 | 0.046 | G4 |
| | 22) Washing process: one time | | | | |
| | (ion exchange resin is replaced | | | | |
| | with Amberlite 200C) | | | | |
| Example B5 | 21) Washing process: two times | 0.011 | 0.034 | 0.045 | G4 |
| | 22) Washing process: one time | | | | |
| Example B6 | 21) Washing process: five times | 0.007 | 0.013 | 0.020 | G5 |
| | 22) Washing process: two times | | | | |
| Example B7 | 21) Washing process: two times | 0.059 | 0.032 | 0.091 | G3 |
| | 22) Washing process: one time | | | | |
| | (without heat stiffing) | | | | |
| Comparative | 21) Washing process: one time | 0.115 | 0.027 | 0.142 | G1 |
| Example B1 | 22) Washing process: None | | | | |

From the above results, it can be seen that concerning the evaluation of the stability of display repetition, good results are obtained in Examples as compared with Comparative Examples.

What is claimed is:

1. An electrophoretic particle comprising:
a polymer and a coloring agent, wherein the total content of a calcium element and a sodium element or a magnesium element and a sodium element is about 0.1% by mass or less.

2. An electrophoretic particle dispersion liquid comprising:
a dispersion medium and
an electrophoretic particle dispersed therein, wherein the electrophoretic particle is the electrophoretic particle according to claim 1.

3. A display medium comprising:
a pair of substrates at least one of which has a light-transmitting property, and
the electrophoretic particle dispersion liquid according to claim 2, which is enclosed between the pair of substrates.

4. A display medium comprising:
a pair of electrodes at least one of which has light-transmitting property, and
an area having the electrophoretic particle dispersion liquid according to claim 2, which is provided between the pair of electrodes.

5. A display device comprising:
the display medium according to claim 3 and
a voltage-applying unit that applies a voltage to between the pair of substrates of the display medium.

6. A display device comprising:
the display medium according to claim 4 and
a voltage-applying unit that applies a voltage to between the pair of electrodes of the display medium.

7. A method of manufacturing an electrophoretic particle, the method comprising:
suspending a polymerization component, a coloring agent, calcium carbonate and sodium chloride or magnesium carbonate and sodium chloride in an aqueous phase,
polymerizing the polymerization component to a polymer,
obtaining the electrophoretic particle which are composed by containing the polymer and the coloring agent,
wherein the total content of the calcium element and the sodium element or the magnesium element and the sodium element is about 0.1% by mass or less.
